(19) United States
(12) Patent Application Publication
(10) Pub. No.: US 2026/0244189 A1
(43) Pub. Date: Aug. 20, 2026

(54) NUMERICAL CONTROL DEVICE

(71) Applicant: FANUC CORPORATION, Yamanashi (JP)

(72) Inventor: Kazuki WATANABE, Yamanashi (JP)

(73) Assignee: FANUC CORPORATION, Yamanashi (JP)

(21) Appl. No.: 18/853,569

(22) PCT Filed: Aug. 10, 2022
(86) PCT No.: PCT/JP2022/030661

§ 371 Date: Oct. 2, 2024

(51) Int. Cl. G05B 19/4155; B23K 26/14

(52) U.S. Cl. CPC G05B 19/4155; B23K 26/1435

(57) ABSTRACT

A numerical control device according to one aspect of the present invention is capable of shortening the machining time, and is for controlling a machining device that machines a workpiece with a machining head using a gas, in accordance with a machining program including a plurality of instructions. The numerical control device comprises: a settling time acquisition unit that acquires a settling time required from the start of supplying the gas until the supply state of the gas reaches a required state; a prefetch unit that prefetches the instructions of the machining program; a gas supply decision unit that, on the basis of the instructions prefetched by the prefetch unit, decides a start timing to start supplying the gas so that a specific instruction which requires the supply of the gas is executed after the settling time elapses from the start of supplying the gas; and a gas supply control unit that causes the gas to be supplied to the machining device at the start timing decided by the gas supply decision unit.

### TECHNICAL FIELD

The present invention relates to a numerical control device.

### BACKGROUND ART

It has been known to blow an appropriate gas to a machining point in order to blow off a material or prevent oxidation of the material during machining such as welding and cutting, for example. A relatively long time is required until a pressure of the gas reaches a predetermined pressure, in comparison with the startup of machining that is performed using a laser, an electric current, or the like. For this reason, in the conventional machining, a tool such as a laser head is first disposed at a machining point, supply of a gas is then started, and thereafter, the machining is started after waiting until the pressure of the gas sufficiently increases.

Patent Document 1 discloses a technique which is intended to shorten machining time and reduce gas consumption, and in which a rate of increase in the gas pressure after the start of supply of the gas is monitored, the startup of a laser is commenced before the gas pressure reaches a predetermined pressure, and the laser is emitted immediately after the gas pressure reaches the predetermined pressure.

### CITATION LIST

### Patent Document

Patent Document 1: Japanese Unexamined Patent Application, Publication No. 2008-68305

### DISCLOSURE OF THE INVENTION

### Problems to be Solved by the Invention

While the method disclosed in Patent Document 1 can reduce the standby time at the machining point, further shortening of the machining time is desired.

### Means for Solving the Problems

An aspect of the present invention relates to a numerical control device for controlling a machining apparatus that performs machining on a workpiece by a machining head while using a gas, in accordance with a machining program that includes a plurality of instructions, the numerical control device including: a settling time acquisition unit configured to acquire a settling time that is necessary for a supply state of the gas to reach a required state from a start of supply of the gas; a pre-reading unit configured to pre-read the instruction in the machining program; a gas supply decision unit configured to decide, based on the instruction pre-read by the pre-reading unit, a start timing at which the supply of the gas is to be started such that a specific instruction involving the supply of the gas will be executed after lapse of the settling time from the start of supply of the gas; and a gas supply control unit configured to cause the gas to be supplied to the machining apparatus at the start timing decided by the gas supply decision unit.

### Effects of the Invention

The present disclosure makes it possible to shorten a machining time.

### BRIEF DESCRIPTION OF THE DRAWINGS

FIG. 1 is a block diagram illustrating a configuration of a numerical control device according to an embodiment of the present disclosure; and

FIG. 2 is a time chart illustrating a relationship between a machining program and control outputs in the numerical control device of FIG. 1.

### PREFERRED MODE FOR CARRYING OUT THE INVENTION

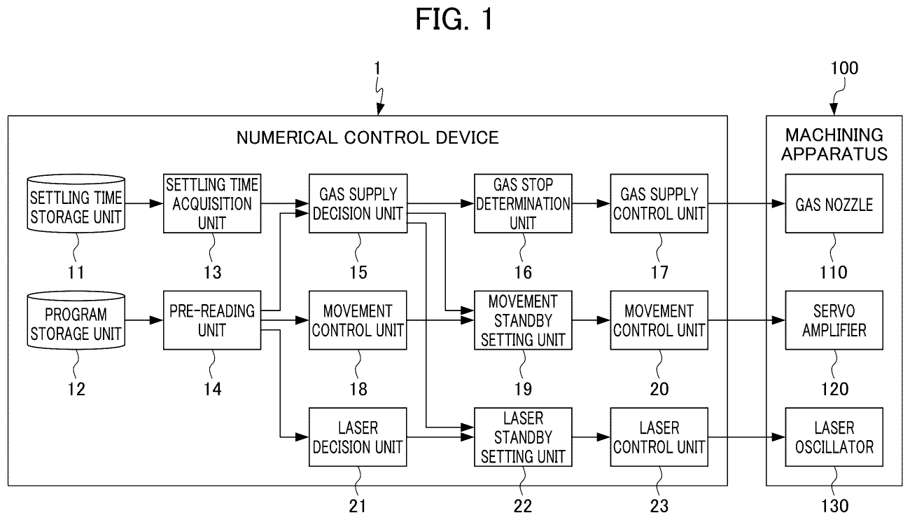

Embodiments of the present disclosure will be described below with reference to the drawings. FIG. 1 is a block diagram illustrating a configuration of a numerical control device 1 according to an embodiment of the present disclosure.

The numerical control device 1 controls a machining apparatus 100. The machining apparatus 100 is an apparatus that machines a workpiece (not shown) by a machining head (not shown) while using a gas. Examples of the machining performed by the machining apparatus 100 include laser welding, laser cutting, arc welding, plasma cutting, gas welding, gas cutting, etc. In the illustrated embodiment, the machining apparatus 100 is assumed to be a laser machining apparatus including a laser head as a machining head, which irradiates a workpiece with a laser, and further including a gas nozzle 110 that ejects a gas to a region irradiated with the laser, a servo amplifier 120 that drives a plurality of motors for relatively moving the laser head and the workpiece, and a laser oscillator 130 that supplies the laser to the laser head.

The numerical control device 1 controls the machining apparatus 100 in accordance with a machining program including a plurality of instructions. The numerical control device 1 includes, for example, a memory, a processor, and an input/output interface, etc., and can be realized by a computer device that executes an appropriate control program. The numerical control device 1 includes a settling time storage unit 11, a program storage unit 12, a settling time acquisition unit 13, a pre-reading unit 14, a gas supply decision unit 15, a gas stop determination unit 16, a gas supply control unit 17, a movement decision unit 18, a movement standby setting unit 19, a movement control unit 20, a laser decision unit 21, a laser standby setting unit 22, and a laser control unit 23. It should be noted that these constituent elements result from categorization of the functions of the numerical control device 1 that relate to the present invention, and do not have to be clearly distinguishable from each other in terms of physical configuration and program configuration.

The settling time storage unit 11 stores a settling time that is necessary for a supply state of the gas to reach a required state from a start of supply of the gas. Examples assumed as the required supply state of the gas include a state in which the pressure of the gas is equal to or higher than a target pressure, a state in which the concentration of the gas is equal to or higher than a target concentration, and similar states. A plurality of settling times may be stored in correspondence with the types of gases, target pressures, and the like. Alternatively, the settling time may be stored as a function of a target value.

The program storage unit 12 stores therein a machining program describing a machining procedure for the machining apparatus 100 to machine a workpiece. The machining program may be described in a programming language such as the G-code or the like. The program storage unit 12 may store a plurality of machining programs.

The settling time acquisition unit 13 acquires a settling time of a gas that is used in the machining that is underway. Specifically, the settling time acquisition unit 13 reads the settling time from the settling time storage unit 11 and stores it in a working memory.

The pre-reading unit 14 pre-reads an instruction from the machining program. Specifically, the pre-reading unit 14 reads in advance an instruction subsequent to an instruction that is being executed by the machining apparatus 100 from the program storage unit 12 and stores the read instruction in a working memory. In this way, the numerical control device 1 can decide in advance a subsequent operation schedule for the machining apparatus 100, and can cause the machining apparatus 100 to perform machining in accordance with the machining program without a delay that can be caused due to computation.

The gas supply decision unit 15 decides, based on the instruction pre-read by the pre-reading unit 14, a start timing at which the supply of the gas is to be started such that an instruction that involves the supply of the gas (hereinafter, referred to as the specific instruction) will be executed after the settling time elapses from the start of the supply of the gas. In other words, the gas supply decision unit 15 sets, as the start timing, a clock time that is earlier by the settling time than the time at which the execution of the specific instruction is started according to the machining program. The gas supply decision unit 15 further decides a stop timing such that the supply of the gas is stopped simultaneously with completion of the execution of the specific instruction or with a delay of a predetermined time, based on the instruction pre-read by the pre-reading unit 14.

Examples of the specific instruction include an instruction to start the supply of the gas, in addition to an instruction to start machining in which the gas is used. In a machining program created for a conventional numerical control device, in general, an instruction to start the supply of a gas is provided immediately before an instruction to start machining. Therefore, in a case where machining is performed based on the conventional machining program, the gas supply decision unit 15 may decide a start timing at which the supply of the gas is started, while considering that the instruction to start the supply of the gas involves the instruction to start the machining. The gas supply decision unit 15 may ignore the instruction to start the supply of the gas and decide the start timing to start the supply of the gas based on the instruction to start the machining. Thus, the instruction to start the supply of the gas can be omitted from the machining program created for the numerical control device 1.

The start timing may be specified by means of a clock time or a position of the machining head. In general, the machining head is moved to a machining point immediately before the start of machining, and therefore, the supply of the gas can be appropriately started by specifying a position of the machining head corresponding to the start timing, from a movement speed for positioning the machining head.

The gas supply decision unit 15 is not allowed to go back by the settling time from the start clock time of the specific instruction in a case where the settling time cannot be ensured before the specific instruction is executed, and examples of such a case include a case where the specific instruction is described immediately after the beginning of the program, immediately after the acquisition of a machining condition, immediately after an instruction to prohibit gas injection, or the like. In such a case, a shortage of time is calculated by subtracting, from the start clock time of the specific instruction, a maximum time by which the gas supply decision unit 15 is allowed to go back. The shortage of time may be a value obtained by adding a margin to a simple difference or a value obtained by multiplying a simple difference by a safety factor.

The gas stop determination unit 16 determines whether or not the supply of the gas is to be stopped upon completion of execution of the specific instruction, based on one or more instructions subsequent to the specific instruction. Specifically, in a case where a period from the stop timing for the supply of the gas corresponding to a specific instruction as a reference to the start timing for the supply of the gas corresponding to a next specific instruction is equal to or less than a predetermined continuation threshold, the gas stop determination unit 16 determines that the supply of the gas corresponding to the specific instruction as the reference should not be stopped so as to continue without interruption to the supply of the gas corresponding to the next specific instruction. That is, the gas stop determination unit 16 corrects the stop timing for the supply of the gas in the gas supply schedule decided by the gas supply decision unit 15. The continuation threshold may be set to zero. In a case where the stop timing corresponding to the specific instruction as the reference is later than the start timing corresponding to the next specific instruction, it is naturally determined that the supply of the gas should be continued.

The gas supply control unit 17 causes the gas to be supplied to the machining apparatus 100 at the start timing decided by the gas supply decision unit. More specifically, the gas supply control unit 17 controls the gas nozzle 110 in accordance with the schedule decided by the gas supply decision unit 15 and corrected by the gas stop determination unit 16.

The movement decision unit 18 decides a movement profile for the machining head based on the instruction pre-read by the pre-reading unit 14. Specifically, the movement decision unit 18 calculates the coordinates of the machining head for each clock time or a position of a drive motor according to which the coordinates are determined.

The movement standby setting unit 19 stops the relative movement between the machining head and the workpiece for a time corresponding to the shortage of time calculated by the gas supply decision unit 15, immediately before a start of the machining. That is, the movement standby setting unit 19 corrects the movement profile decided by the movement decision unit 18 such that the start of the machining is delayed until the supply state of the gas reaches the required state.

The movement control unit 20 inputs a command value to the servo amplifier 120 such that the machining head performs relative movement according to the profile decided by the movement decision unit 18 and corrected by the movement standby setting unit 19.

The laser decision unit 21 decides a profile of a temporal change in a setting value of output from the laser oscillator 130, based on the instruction pre-read by the pre-reading unit 14.

Similarly to the movement standby setting unit 19, the laser standby setting unit 22 delays a start of output of the laser for a time equal to the shortage of time calculated by the gas supply decision unit 15, immediately before the start of the machining. That is, the laser standby setting unit 22 corrects a profile of the laser output decided by the laser decision unit 21 such that the start of the machining is delayed until the gas supply state reaches the required state.

The laser control unit 23 controls the laser oscillator 130 to change the laser output in accordance with the profile decided by the laser decision unit 21 and corrected by the laser standby setting unit 22.

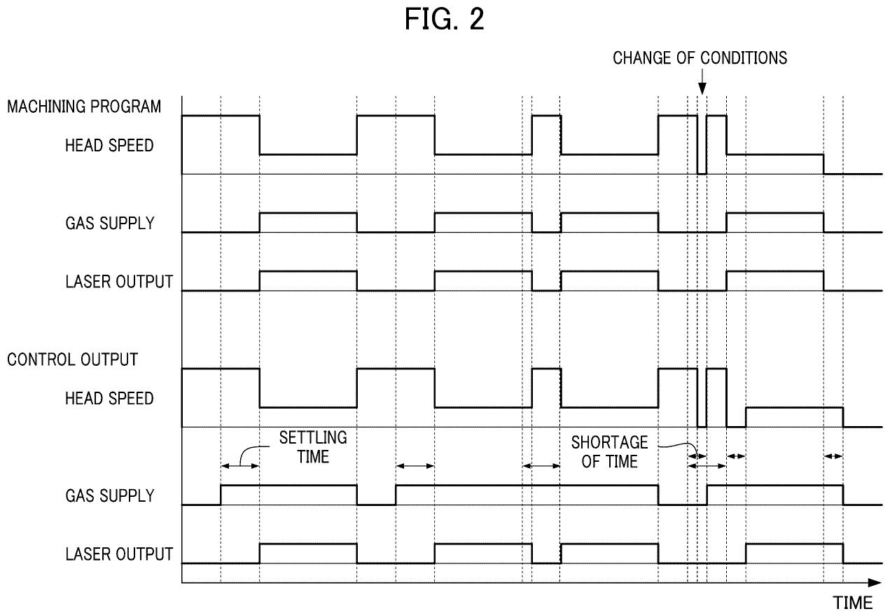

FIG. 2 illustrates in a simplified manner a relationship between temporal changes as described in a machining program and temporal changes in control outputs (outputs from the gas supply control unit 17, the movement control unit 20, and the laser control unit 23), in relation to the supply of the gas, the movement of the machining head, and the laser output in the numerical control device 1. The machining head is programmed to move at a high speed during positioning, and to move at a low speed during machining. In the range illustrated, the machining program includes machining operations appearing at four locations. Between the third and fourth machining operations, the machining conditions are changed, which include, for example, a change of the type or pressure of the gas, and at that time, it is necessary to stop the supply of the gas.

In the control outputs of this example, the supply of the gas for each of the first and second machining operations is started at a clock time earlier than the start of machining (movement of the machining head and output of laser) by a settling time. The supply of the gas for the third machining operation is performed continuously from the supply of the gas for the second machining operation because the time interval between the second and third machining operations is shorter than the settling time. Although the supply of the gas for the fourth machining operation is started just after the change of the conditions, which takes place immediately before the fourth machining operation, since the settling time cannot be ensured at the machining start clock time described in the machining program, the start of the machining is delayed by the shortage of time. By virtue of this profile of the control outputs, the numerical control device 1 starts the laser machining after the gas supply state reaches the required state, whereby appropriate machining can be reliably performed.

It should be noted that the present disclosure is not limited to the embodiment described above. The above embodiment merely describes preferred effects exerted by the present invention, and the effects of the present invention are not limited to those described in the above embodiment.

For example, the numerical control device according to the present invention does not necessarily have to include the gas stop determination unit, the movement standby setting unit, and the laser standby setting unit. In addition, the numerical control device according to the present invention may be devoid of the settling time storage unit and the program storage unit and may be configured such that the settling time acquisition unit and the pre-reading unit acquire information from exterior equipment.

### EXPLANATION OF REFERENCE NUMERALS

1: Numerical control device
11: Settling time storage unit
12: Program storage unit
13: Settling time acquisition unit
14: Pre-reading unit
15: Gas supply decision unit
16: Gas stop determination unit
17: Gas supply control unit
18: Movement decision unit
19: Movement standby setting unit
20: Movement control unit
21: Laser decision unit
22: Laser standby setting unit
23: Laser control unit
100: Machining apparatus
110: Gas nozzle
120: Servo amplifier
130: Laser oscillator

1. A numerical control device for controlling a machining apparatus that performs machining on a workpiece by a machining head while using a gas, in accordance with a machining program that includes a plurality of instructions, the numerical control device comprising:
a settling time acquisition unit configured to acquire a settling time that is necessary for a supply state of the gas to reach a required state from a start of supply of the gas;
a pre-reading unit configured to pre-read the instruction in the machining program;
a gas supply decision unit configured to decide, based on the instruction pre-read by the pre-reading unit, a start timing at which the supply of the gas is to be started such that a specific instruction involving the supply of the gas will be executed after lapse of the settling time from the start of supply of the gas; and
a gas supply control unit configured to cause the gas to be supplied to the machining apparatus at the start timing decided by the gas supply decision unit.

2. The numerical control device according to claim 1, further comprising:
a gas stop determination unit configured to determine whether or not the supply of the gas is to be stopped upon completion of execution of the specific instruction, based on the instruction subsequent to the specific instruction.

3. The numerical control device according to claim 1, further comprising:
a movement standby setting unit configured to stop relative movement between the
machining head and the workpiece immediately before a start of the machining, wherein in a case where the settling time cannot be ensured before the specific instruction is executed, the gas supply decision unit calculates a shortage of time, and
the movement standby setting unit stops the relative movement between the machining head and the workpiece for a time equal to the shortage of time.

4. The numerical control device according to claim 1, wherein
the specific instruction is an instruction to start the supply of the gas or start the machining.
